(19) United States
(12) Patent Application Publication
(10) Pub. No.: US 2023/0258559 A1
(43) Pub. Date: Aug. 17, 2023

(54) LASER HETERODYNE COMBUSTION-EFFICIENCY MONITOR AND ASSOCIATED METHODS

(71) Applicant: Onpoint Technologies, LLC, Wichita, KS (US)

(72) Inventor: Andrew D. SAPPEY, Lakewood, CO (US)

(73) Assignee: Onpoint Technologies, LLC, Wichita, KS (US)

(21) Appl. No.: 18/014,472

(22) PCT Filed: Jul. 1, 2021
(86) PCT No.: PCT/IB2021/055932

§ 371 Date: Jan. 4, 2023

Related U.S. Application Data
(60) Provisional application No. 63/052,054, filed on Jul. 15, 2020.

(51) Int. Cl. G01N 21/39; G01N 21/72; G01N 21/3504

(52) U.S. Cl. CPC G01N 21/39; G01N 21/72; G01N 21/3504; G01N 2021/399; G01N 2021/3531

(57) ABSTRACT

A laser-heterodyne combustion-efficiency monitor captures light emitted from a combustion zone during combustion and determines combustion efficiency based on the captured light. The monitor includes an optical detector that generates an electrical response by mixing the captured light with an optical local-oscillator signal, and a signal filter that filters the electrical response to isolate a beat-note that is proportional to a target-species concentration in the combustion zone. The frequency of the local-oscillator signal determines the target species, which may be carbon monoxide, carbon dioxide, or another emission or absorption line that can be detected using laser-heterodyne radiometry. A laser generates the local-oscillator signal. The monitor may be extended to operate with several lasers emitting several local-oscillator signals at different frequencies, thereby allowing multiple target species to be detected simultaneously.

### RELATED APPLICATIONS

This application claims priority U.S. Provisional Pat. Application No. 63/052,054, filed Jul. 15, 2020, which is incorporated herein by reference in its entirety.

### APPENDIX

Appendix A contains, for disclosure purposes, a paper by inventors hereof and entitled “Development of a Passive Optical Heterodyne Radiometer for NIR Spectroscopy”.

### BACKGROUND

In a range of combustion and manufacturing processes it is necessary to monitor the efficiency of a combustion system to maintain adequate operation. Combustion systems including engines and flare stacks are among those that have flames and combusting precursors. These combustion systems require specific ratios of fuel and air and depend on consistent mixing of the two in order to maintain satisfactory combustion efficiency.

### SUMMARY OF THE EMBODIMENTS

Combustion processes require monitoring to satisfy standard operating conditions. Due to high temperatures and volatile environments within flames, direct sensing of combustion systems is challenging. Spectroscopy has been used to monitor flames, though many spectroscopic monitoring systems require significant expense and often require careful alignment of delicate optical components. During combustion, carbon monoxide (CO) and carbon dioxide (CO₂) are generated. The amount of CO generated is indicative of the combustion efficiency of the fuel. Monitoring the amount of CO in a flame allows for an estimate of the combustion efficiency in real time. Since flames are volatile, the measured amount of CO may vary as a result of flame motion or uneven mixing. To control for such variabilities, the measured CO concentration can be normalized by comparison to measured CO₂ concentration. This is useful, for example, if the detection efficiency of the measurement varies.

Embodiments disclosed herein monitor the efficiency of combustion systems without invasive probes or installation of complex optics. Instead, a laser heterodyne combustion-efficiency monitor is disclosed that captures light emitted from a combustion zone during combustion and determines combustion efficiency based upon the collected light. The laser heterodyne combustion-efficiency monitor need not be directly adjacent to the combustion zone; nor does it require direct mounting to the combustion system creating the combustion zone. Advantageously, the heterodyne combustion-efficiency monitor may instead be placed far enough away from the combustion zone to avoid the high temperatures associated with combustion processes.

In a first aspect, a laser heterodyne combustion-efficiency monitor includes an optical detector that generates an electrical response by mixing an emission signal from a combustion zone with a light signal. The laser heterodyne combustion-efficiency monitor further includes a signal filter that filters the electrical response to isolate a beat-note component proportional to a target-species concentration in the combustion zone.

In a second aspect, a method for monitoring combustion efficiency includes overlapping an emission signal from a combustion zone with a light signal on to an optical detector to generate an electrical response, and filtering the electrical response to isolate a beat-note component.

In a third aspect, a method for measuring the concentration of a species in a combustion zone includes, for each oscillator frequency of a plurality of oscillator frequencies, i) overlapping an emission signal from a combustion zone with a light signal onto an optical detector to generate an electrical response, ii) filtering the electrical response to isolate a beat-note component, and iii) recording the beat-note component with a signal detector. The method also includes plotting the beat-note component for each oscillator frequency to generate a spectrum and included determining concentration of at least one species in the combustion zone based on the spectrum.

In a fourth aspect, a method for monitoring combustion efficiency includes i) overlapping an emission signal from a combustion zone with a light signal onto an optical detector to generate an electrical signal and ii) filtering the electrical response with a plurality of sub-filters, each of the sub-filters having a frequency range and isolating a portion of the electrical response based upon the frequency range.

In a fifth aspect, a method for monitoring combustion efficiency using laser heterodyne radiometry includes, for each local oscillator of a plurality of local oscillators, i) generating a light signal with the local oscillator, ii) overlapping an emission signal from a combustion zone with the light signal onto an optical detector to generate and electrical response, and iii) filtering the electrical response with a signal filter to isolate the beat-note component.

### BRIEF DESCRIPTION OF THE FIGURES

FIG. 1 illustrates a laser heterodyne combustion-efficiency monitor, according to an embodiment.

FIG. 2 illustrates the laser heterodyne combustion-efficiency monitor of FIG. 1 with an optical coupler, according to an embodiment.

FIG. 3 illustrates the laser heterodyne combustion-efficiency monitor of FIG. 1 with a plurality of local oscillators, according to an embodiment.

FIG. 4 illustrates the laser heterodyne combustion-efficiency monitor of FIG. 1 with a plurality of sub-filters and a plurality of sub-detectors, according to an embodiment.

FIG. 5 shows a flowchart illustrating one method for monitoring combustion efficiency, in an embodiment.

FIG. 6 shows a flowchart illustrating one method for measuring a concentration of a species in a combustion zone, in an embodiment.

FIG. 7 shows a flowchart illustrating one method for monitoring combustion efficiency, in an embodiment.

FIG. 8 shows a flowchart illustrating one method for monitoring combustion efficiency using laser heterodyne radiometer, in an embodiment.

### DETAILED DESCRIPTION OF ILLUSTRATED EMBODIMENTS

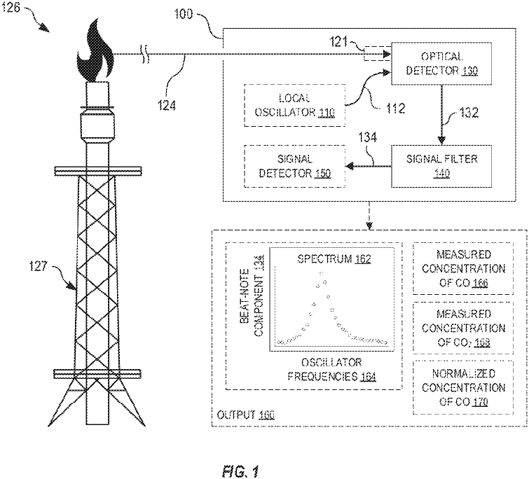

FIG. 1 illustrates a laser heterodyne combustion-efficiency monitor 100 that monitors a combustion zone 126 created from a combustion system 127. The laser heterodyne combustion-efficiency monitor 100 includes an optical detector 130 that mixes a light signal 112 and an emission signal 124 emitted by the combustion zone 126 to generate an electrical response 132. The laser heterodyne combustion-efficiency monitor 100 includes a signal filter 140 that receives the electrical response 132 and isolates a beat-note component 134 contained therein. In an embodiment, the laser heterodyne combustion-efficiency monitor 100 includes a local oscillator 110 that generates the light signal 112. The laser heterodyne combustion-efficiency monitor 100 may include a signal detector 150 that records the beat-note component 134. The light signal 112 may have a frequency associated with MIR light or with NIR light.

When two light beams, each with intrinsic oscillating frequencies, are heterodyned, the resulting signal includes two distinct electromagnetic components, one with oscillating frequency equal to the sum of the two incoming frequencies and one with an oscillating frequency equal to the difference of the two incoming frequencies, known as the difference-frequency component. This is true of the electrical response 132 of FIG. 1. Signal filter 140 filters the electrical response 132 to isolate the difference-frequency component. In an embodiment, the light signal 112 is generated at infrared frequencies. The signal filter 140 excludes portions of the electrical response 132 with frequencies above 50 MHz, leaving the beat-note component 134. This is represented by Equation 1, below, where v₁₁₂ is the frequency of the light signal 112 and v₁₂₄ is the frequency of the emission signal 124. The signal filter 140 suppresses the second term of right-hand side of Equation 1 and isolates the first term of the right-hand-side, which is represented by the beat-note component 134.

$$\begin{matrix}sin \left(2 π {v}_{112} t\right) sin \left(\left(2 \text{π} {v}_{124} t\right)\right) = \\ \frac{1}{2} cos \left(2 π \left({v}_{112} - {v}_{112}\right) t\right) - \frac{1}{2} cos \left(2 π \left({v}_{112} + {v}_{112}\right) t\right)\end{matrix} \qquad \text{(1)}$$

In an embodiment, the light signal 112 is conveyed from the local oscillator 110 to the optical detector 130 by a fiber optic cable. In an embodiment, the electrical response 132 and the beat-note component 134 are conveyed via an electrically conductive medium, e.g. a coaxial cable. In an embodiment, the emission signal 124 is directed into the optical detector 130 by a fiber optic input coupler 121.

The laser heterodyne combustion-efficiency monitor 100 may generate multiple data elements shown as output 160. In an embodiment, one data element is a spectrum 162, which spans an absorption feature of a chemical species present in the combustion zone 126. In an embodiment, the local oscillator 110 generates the light signal 112 at multiple frequencies within a range of oscillator frequencies 164. At each of the oscillator frequencies 164, the signal detector 150 records the beat-note component 134. A given point on the spectrum 162 represents a single oscillator frequency 164(1) and a single beat-note component 134(1) corresponding to the local oscillator 110 generating a light signal 112(1) at the oscillator frequency 164(1). Appendix A provides more detail on how spectrum 162 is generated.

Laser heterodyne combustion-efficiency monitor 100 does not need to be physically mounted to the combustion system 127 or be adjacent to the combustion zone 126. Instead, laser combustion-efficiency monitor 100 may be positioned remote to the combustion zone 126, for example several meters away from combustion zone 126.

In an embodiment, the local oscillator 110 generates the light signal 112 at at least one frequency associated with carbon monoxide (CO). In this embodiment, the beat-note component 134 recorded by the signal detector 150 is proportional to a measured concentration of CO 166 in the combustion zone 126.

In an embodiment, the local oscillator 110 generates the light signal 112 at at least one frequency associated with carbon dioxide (CO₂). In this embodiment, the beat-note component 134 recorded by the signal detector 150 is proportional to a measured concentration of CO₂ 168 in the combustion zone 126. The measured concentration of CO₂ can be used to normalize the measure concentration of CO 166 to generate a normalized concentration of CO 170, which removes contributions to noise as well as corrects for variable path length that would otherwise reduce the accuracy of the measured concentration of CO 166.

The local oscillator 110 may generate the light signal 112 at one or more frequencies associated with solar emission and/or atmospheric absorption. Operating the laser heterodyne combustion-efficiency monitor 100 at frequencies associated with solar emission and/or atmospheric absorption allows for calibration of the laser heterodyne combustion-efficiency monitor 100. Solar emission and atmospheric absorption are readily available during daytime operation and have reliable frequency characteristics, making them advantageous calibration targets and allowing for calibration without additional required equipment.

In an embodiment, the local oscillator 110 generates the light signal 112 within a Fraunhofer-Dark-Space frequency range in the vicinity of 4.539 microns. Operating in this frequency region is beneficial because, during daytime operation, laser heterodyne combustion-efficiency monitor 100 may detect sunlight with frequencies similar to the frequency of the light signal 112. Detection of sunlight contributes to noise and leads to inaccuracies, for example in the measured concentration of CO 166. Generating light signal 112 within a Fraunhofer-Dark-Space frequency range helps reduce detection of sunlight because there is reduced solar emission within the Fraunhofer-Dark-Space frequency range. To reduce noise, light signal 112 may be generated at one or more frequencies that do not exhibit contributions from other combustion species. Light generated by other combustion species and within the frequency range detected by the signal detector 150 will be falsely attributed to, for example, the CO emission and negatively affect the accuracy of the laser heterodyne combustion-efficiency monitor 100.

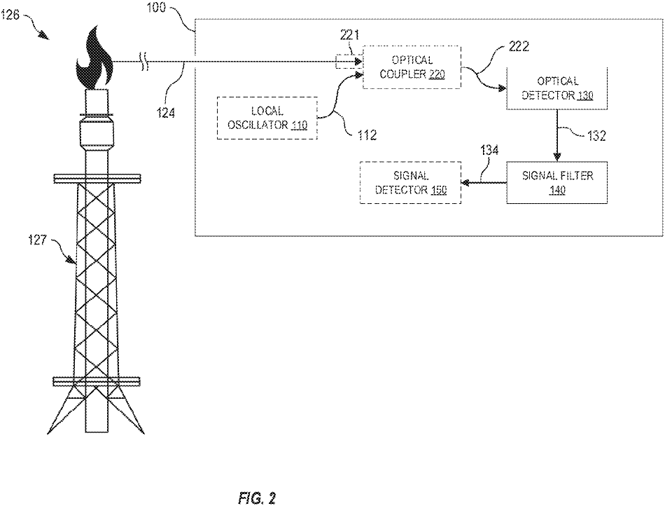

FIG. 2 illustrates the laser heterodyne combustion-efficiency monitor 100 of FIG. 1 with an optical coupler 220. The output coupler 220 receives the light signal 112 and the emission signal 124 and couples them together to form the superimposed signal 222, which is received by the optical detector 130. The optical coupler 220 may couple the light signal 112 and emission signal 124 together at ratios of one to one to form the superimposed signal 222, though other ratios may be used in the coupling without departing from the scope hereof. For example, the optical coupler 220 may couple the light signal 112 and the emission signal 124 together at a ratio of 1 to 9 to form the superimposed signal 222, which advantageously increases sensitivity. The optical coupler 220 may couple the light signal 112 and the emission signal 124 at ratios between 1:5 to 1:20 based upon the power of the emission signal 124 and the noise level. Increased sensitivity is useful for example when emission signal 124 is weaker than the light signal 112. A fiber optic input coupler 221 may be used to direct the emission signal 124 into the optical coupler 220.

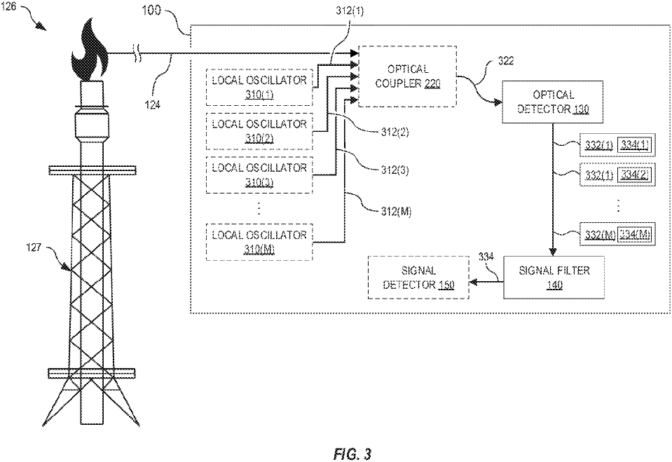

FIG. 3 illustrates the laser heterodyne combustion-efficiency monitor 100 of FIG. 2 with a plurality of local oscillators 310 that generate a plurality of light signals 312. Each of the local oscillators 310(M) generates one of the light signals 312(M), as shown. For example, a local oscillator 310(1) generates a light signal 312(1). The plurality of light signals 312 is received by the optical coupler 220, which creates a plurality of superimposed signals 322 by combining each of the plurality of light signals 312 with the emission signal 124. In this case, the optical detector 130 mixes each of the plurality of superimposed signals 322 to generate one of a plurality of electrical responses 332, each containing a beat-note component 334(M), to form a plurality of beat-note components 334. The signal filter 140 filters each of the plurality of electrical responses 332, to isolate its corresponding beat-note component 334(M), for recording by the signal detector 150. The signal detector 150 records the beat note component 334(M) corresponding to each local oscillator 310(M).

For example, local oscillator 310(2) generates light signal 312(2), which is used to generate a superimposed signal 322(2). Optical detector 130 mixes the superimposed signal 322(2) to generate an electrical response 332(2) that contains a beat-note component 334(2). Signal filter 140 isolates the beat-note component 334(2), which is recorded by the signal detector 150.

When each of the plurality of beat-note components 334 is plotted with respect to the frequency range of the corresponding light signal 312, the spectrum 162 is generated. The plurality of local oscillators 310 is advantageous because each local oscillator 310(M) needs only generate the light signal 312 at a single frequency.

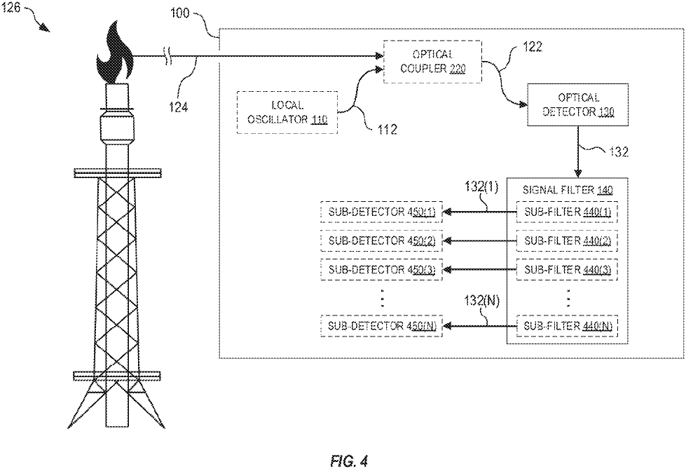

FIG. 4 illustrates the laser heterodyne combustion-efficiency monitor 100 of FIG. 1 with a plurality of sub-filters 440 and a plurality of sub-detectors 450. Each of the plurality of sub-filters 440 is associated a frequency range to isolate a corresponding portion of the electrical response 132. For example, sub-filter 440(1) isolates a portion of the electrical response 132(1).

Each sub-detector 450(N) is communicatively coupled to one sub-filter 440(N), as shown. For example, sub-detector 450(2) is communicatively coupled to sub-filter 440(2). Each of the sub-detectors 450 records the portion of the electrical response 132 isolated by its corresponding sub-filter 440. The portions of the electrical response 132 recorded by the sub-detectors 450, when graphed versus the frequency ranges of the corresponding sub-filter 440, generates the spectrum 162.

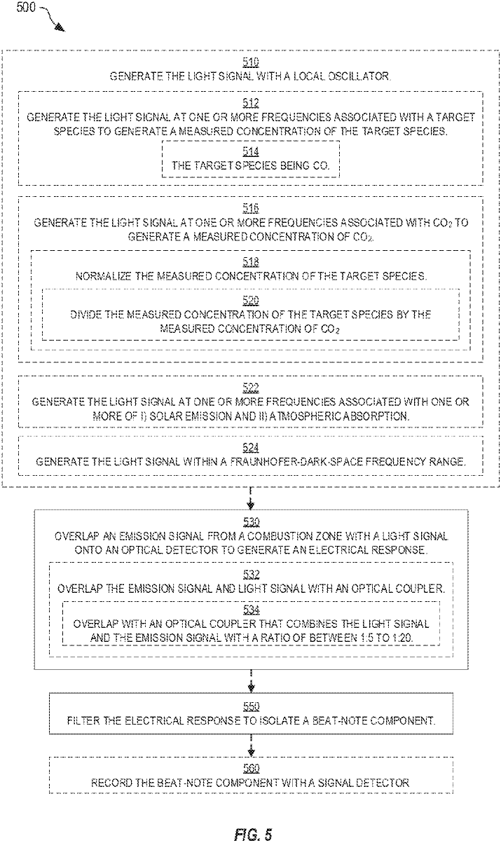

FIG. 5 is a flowchart illustrating a method 500 for monitoring combustion efficiency. The method 500 is for example implemented by laser heterodyne combustion-efficiency monitor 100 described above. The method 500 includes blocks 530 and 550. In embodiments, the method 500 includes at least one of blocks 510, 512, 514, 516, 518, 520, 522, 524, 532, 534, and 560.

In block 530, a light signal and an emission signal from a combustion zone is overlapped onto an optical detector to generate an electrical response. In one example of block 530, the light signal 112 emission signal 124 from the combustion zone 126 are overlapped on the optical detector 130.

In block 550, the electrical response is filtered to isolate a beat-note component. In one example of block 550, the electrical response 132 is filtered by the signal filter 140 to isolate the beat-note component 134.

In embodiments, the method 500 includes one or more additional blocks of the flowchart in FIG. 5. In block 510, the light signal is generated with a local oscillator. In one example, the light signal 112 is generated by the local oscillator 110. In block 512, the light signal is generated at one or more frequencies associated with a target species and a measured concentration of the target species is generated. In block 514, the target species is CO. In an example of blocks 512 and 514, the laser heterodyne combustion-efficiency monitor 100 generates the measured concentration of CO 166 when the local oscillator 110 generates the light signal 112 at one or more frequencies associated with CO.

In block 516, the light signal is generated at one or more frequencies associated with CO₂ and a measured concentration of CO₂ is generated. In block 518, the measured concentration of the target species is normalized; and in block 520, the measured concentration of the target species is normalized by dividing by the measured concentration of CO₂. In one example of blocks 516, 518, and 520, the laser heterodyne combustion-efficiency monitor 100 generates the measured concentration of CO₂ 168 when the local oscillator 110 generates the light signal 112 at one or more frequencies associated with CO₂, which is used to generate the normalized concentration of CO 170.

In block 522, the light signal is generated at one or more frequencies associated with one or more of i) solar emission and ii) atmospheric absorption. In one example of block 522, the local oscillator 110 generates the light signal 112 at one or more frequencies associated with solar emission. Detection of well-defined spectral lines within solar emission may be used to calibrate the laser heterodyne combustion-efficiency monitor 100. In one example of block 522, the local oscillator 110 generates the light signal 112 at one or more frequencies associated with atmospheric absorption. Detection of well-defined spectral lines associated with atmospheric emission may be used to calibrate the laser heterodyne combustion-efficiency monitor 100.

In block 524, the light signal is generated within a Fraunhofer-Dark-Space frequency range. In one example of block 524, the local oscillator 110 generates the light signal 112 within a Fraunhofer-Dark-Space frequency range. Due to absorption of light within the sun itself, the solar emission spectrum exhibits reduced emission within Fraunhofer-Dark-Space frequency range. The laser heterodyne combustion-efficiency monitor 100 may detect sunlight depending on the frequency of the light signal 112. By generating the light signal 112 at a frequency that exhibits reduced emission, such as within the Fraunhofer-Dark-Space frequency range, the laser heterodyne combustion-efficiency monitor 100 will detect less light emitted by the sun that otherwise may contribute to noise, thereby improving accuracy and increasing sensitivity.

In block 532, the emission signal and the light signal are overlapped with an optical coupler. In one example of block 532, the emission signal 124 and the light signal 112 are overlapped with the optical coupler 220. In an embodiment, the optical coupler 220 uses fiber optical cables. In block 534, an optical coupler combines the light signal and the emission signal with a ratio of between 1:5 and 1:20. In embodiments, the emission signal 124 is weaker than the light signal 112 and enhancing the relative contribution of the emission signal 124 leads to increased sensitivity of the laser heterodyne combustion-efficiency monitor 100.

In block 560, the beat-note component is recorded with a signal detector. In one example of the block 560, the beat-note component 134 is recorded with the signal detector 150. In an embodiment, recording the beat-note component 134 makes it possible to perform calculations and yield data elements that may be found in the output 160.

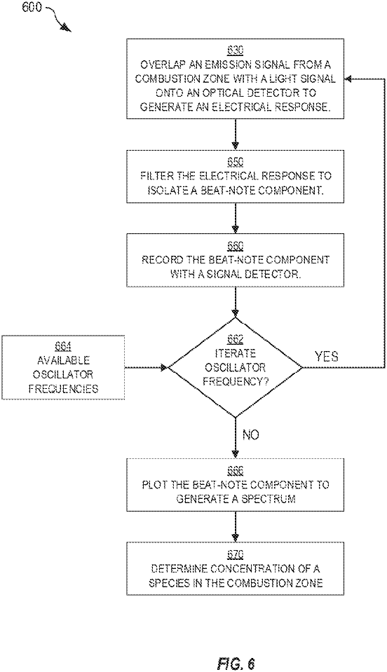

FIG. 6 is a flowchart illustrating a method 600 for measuring a concentration of a species in a combustion zone. The method 600 is for example implemented by laser heterodyne combustion-efficiency monitor 100. The method 600 includes blocks 630, 650, 660, 662, 664, 666 and 670.

In block 630, a light signal and an emission signal from a combustion zone are overlapped onto an optical detector to generate an electrical response. In one example of block 630, the emission signal 124 and the light signal 112 are overlapped on the optical detector 130 to generate an electrical response 132.

In block 650, the electrical response is filtered to isolate a beat-note component. In one example of block 650, the electrical response 132 is filtered by the signal filter 140 to isolate the beat-note component 134.

In block 660, the beat-note component is recorded with a signal detector. In one example of block 660, the beat-note component 134 is recorded with the signal detector 150.

In decision block 662, the oscillator frequency that describes the light signal of block 630 is compared to a list of available oscillator frequencies 664 to determine if the oscillator frequency should be iterated. Decision block 662 compares the available oscillator frequencies 664 to determine i) yes, a new light signal is generated at a new oscillator frequency and blocks 630, 650, and 660 are repeated or ii) no, continue the method 600.

In block 666, the beat-note component is plotted verses the corresponding oscillator frequency to generate a spectrum. In an example of block 666, the beat-note component 134 is plotted verses the oscillator frequency 164 to generate the spectrum 162. In an embodiment, decision block 662 iterates the oscillator frequency but also uses block 666 to plot the beat-note component, updating the plot during each iteration of the oscillator frequency.

In block 670, the concentration of a species in the combustion zone is determined based upon at least the spectrum. In an example of block 670, the measured concentration of CO 166 in combustion zone 126 is determined based upon at least the spectrum 162.

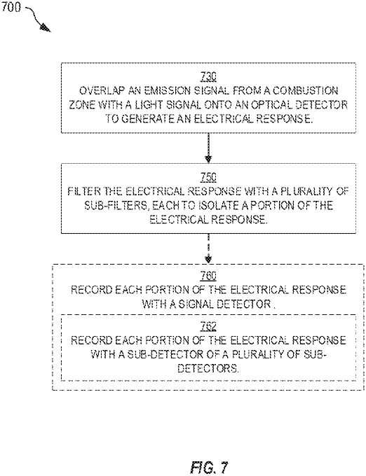

FIG. 7 is a flowchart illustrating a method 700 for monitoring combustion efficiency. The method 700 is for example implemented by laser heterodyne combustion-efficiency monitor 100. The method 700 includes blocks 730 and 750. In embodiments, the method 700 may also include at least one of blocks 760 and 762.

In block 730, a light signal and an emission signal from a combustion zone are overlapped onto an optical detector to generate an electrical response. In one example of block 730, the emission signal 124 and the light signal 112 are overlapped on the optical detector 130 to generate an electrical response 132.

In block 750, the electrical response is filtered with a plurality of sub-filters, each to isolate a portion of the electrical response. In one example of block 750, the electrical response 132 is filtered the plurality of sub-filters 440, each isolating a portion of the electrical response 132.

In block 760, each portion of the electrical response is recorded with a signal detector. In one example of block 760, each portion of the electrical response 132 is recorded by the signal filter 150.

In block 762, each portion of the electrical response is recorded with a sub-detector of a plurality of sub-detectors, each of the sub-detectors corresponding to one of the sub-filters and communicatively coupled thereto. In one example of block 762, the portion of the electrical response 132(1) is recorded by the sub-detector 450(1), which is communicatively coupled to the corresponding sub-filter 440(1).

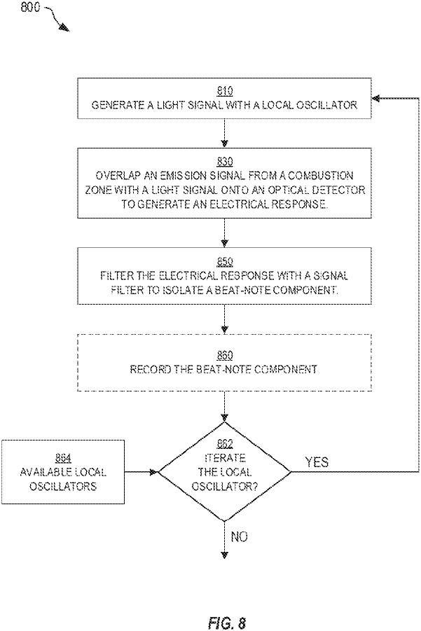

FIG. 8 is a flowchart illustrating a method 800 for monitoring combustion efficiency using laser heterodyne radiometer. The method 800 is for example implemented by laser heterodyne combustion-efficiency monitor 100. The method 800 includes blocks 810, 830, 850, 862, and 864. In embodiments, the method 800 may also include at least block 860.

In block 810, a light signal is generated by a local oscillator. In one example of block 810, the light signal 312(1) is generated by the local oscillator 310(1).

In block 830, a light signal and an emission signal from a combustion zone are overlapped onto an optical detector to generate an electrical response. In one example of block 830, the emission signal 124 and the light signal 312(1) are overlapped on the optical detector 130 to generate an electrical response 332(1).

In block 850, the electrical response is filtered to isolate a beat-note component. In one example of block 850, the electrical response 332 is filtered by the signal filter 140 to isolate the beat-note component 334.

In block 860, the beat-note component is recorded with a signal detector. In one example of block 860, the beat-note component 134 is recorded with the signal detector 150.

In decision block 862, the local oscillator used in block 810 to generate the light signal is compared to a list of available local oscillators 864 to determine if the local oscillator should be iterated. Decision block 862 compares the list of available oscillators 864 to determine i) yes, wherein a new light signal is generated by a new local oscillator and blocks 810, 830, and 850 are repeated, or ii) no, continue the method 800.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

[image]

[image]

[image]

[image]

[image]

[image]

[image]

[image]

What is claimed is:

1. A laser heterodyne combustion-efficiency monitor, comprising:
an optical detector that generates an electrical response by mixing an emission signal from a combustion zone with a light signal;
an optical coupler that overlaps the emission signal and the light signal on the optical detector; and
a signal filter that filters the electrical response to isolate a beat-note component proportional to a target-species concentration in the combustion zone.

2. The laser heterodyne combustion-efficiency monitor of claim 1, further comprising a local oscillator that generates the light signal.

3. The laser heterodyne combustion-efficiency monitor of claim 2, wherein the local oscillator is configured to generate the light signal with a frequency in a range of frequencies.

4. The laser heterodyne combustion-efficiency monitor of claim 2, wherein the local oscillator is configured to generate the light signal at at least one frequency associated with carbon monoxide, the beat-note component being proportional to a measured concentration of carbon monoxide present in the combustion zone.

5. The laser heterodyne combustion-efficiency monitor of claim 2, wherein the local oscillator is configured to generate the light signal at at least one frequency associated with carbon dioxide, the beat-note component being proportional to a measured concentration of carbon dioxide present in the combustion zone.

6. The laser heterodyne combustion-efficiency monitor of claim 2, the local oscillator capable of generating the light signal at one or more frequencies associated with one or more of i) solar emission and ii) atmospheric absorption.

7. The laser heterodyne combustion-efficiency monitor of claim 2, the local oscillator generating the light signal within a Fraunhofer-Dark-Space frequency range in the vicinity of 4.539 microns.

8. (canceled)

9. The laser heterodyne combustion-efficiency monitor of claim 1, the optical coupler being configured to couple the light signal with the emission signal at a ratio of between 1 to 5 and 1 to 20.

10. The laser heterodyne combustion-efficiency monitor of claim 1, further comprising a plurality of local oscillators, each of the local oscillators generating a light signal with a distinct frequency.

11. The laser heterodyne combustion-efficiency monitor of claim 1, further comprising a signal detector that records the beat-note component.

12. The laser heterodyne combustion-efficiency monitor of claim 1, wherein the signal filter comprises a plurality of sub-filters, each of the sub-filters having a corresponding frequency range and isolating a corresponding portion of the electrical response.

13. The laser heterodyne combustion-efficiency monitor of claim 10, further comprising a plurality of sub-detectors, each of the sub-detectors communicatively coupled to one of the sub-filters.

14. A method for monitoring combustion efficiency, comprising:
overlapping an emission signal from a combustion zone with a light signal using an optical coupler onto an optical detector that generates an electrical response; and
filtering the electrical response to isolate a beat-note component.

15. The method of claim 14, further comprising generating, with a local oscillator, the light signal.

16. The method of claim 15, further comprising generating the light signal at one or more frequencies associated with a target species, the beat-note component being proportional to a measured concentration of the target species.

17. The method of claim 16, further comprising generating the light signal at one or more frequencies associated with carbon dioxide, the beat-note component being proportional to a measured concentration of carbon dioxide.

18. The method of claim 17, further comprising normalizing the measured concentration of the target species.

19. The method of claim 18, further comprising dividing the measured concentration of the target species by the measured concentration of carbon dioxide.

20. The method of claim 16, the target species being carbon monoxide.

21. The method of claim 15, further comprising generating the light signal at one or more frequencies associated with one or more of i) solar emission and ii) atmospheric absorption.

22. The method of claim 15, further comprising generating the light signal within a Fraunhofer-Dark-Space frequency range in the vicinity of 4.539 microns.

23. (canceled)

24. The method of claim 14, wherein the optical coupler combines the light signal and the emission signal with a ratio of between 1 to 5 and 1 to 20.

25. The method of claim 14, further comprising recording, with a signal detector, the beat-note component.

26. The method according to claim 14, further comprising:
recording the beat-note component with a signal detector;
plotting the beat-note component for each oscillator frequency to generate a spectrum; and
determining concentration of at least one species in the combustion zone based on the spectrum.

27-31. (canceled)
